(19) United States
(12) Patent Application Publication
(10) Pub. No.: US 2015/0273801 A1
(43) Pub. Date: Oct. 1, 2015

(54) SKIN-COVERED FOAMED MOLDED ARTICLE AND ENERGY ABSORBING MEMBER

(71) Applicant: JSP CORPORATION, Tokyo (JP)

(72) Inventors: Tomoo TOKIWA, Kanuma-shi (JP); Hiroki KAWAKAMI, Utsunomiya-shi (JP)

(73) Assignee: JSP CORPORATION, Tokyo (JP)

(21) Appl. No.: 14/666,721

(22) Filed: Mar. 24, 2015

(30) Foreign Application Priority Data
Mar. 28, 2014 (JP) 2014-67534

(51) Int. Cl. B32B 27/06; B32B 27/32; B32B 27/28

(52) U.S. Cl. CPC B32B 27/065; B32B 27/28; B32B 27/32; B32B 2266/025; B32B 2307/72; B32B 2307/536; B32B 2307/56; B32B 2250/02; B32B 2250/24

(57) ABSTRACT

A skin-covered foamed molded article composed of a polystyrene-based resin expanded beads molded article, and a skin that covers a substantially entire surface of the expanded beads molded article, wherein the skin is formed of an olefinic thermoplastic elastomer and covers the expanded beads molded article in such a manner that the skin is in contact with the surface thereof but is unbonded thereto.

### TECHNICAL FIELD

This invention relates to a skin-covered foamed molded article and an energy absorbing member using same.

### BACKGROUND OF THE INVENTION

Polystyrene-based resin expanded beads foamed molded articles obtained by fuse-bonding polystyrene-based resin expanded beads in a mold cavity are well-balanced in terms of lightness in weight and mechanical properties such as rigidity and are widely used as fish boxes, cushioning materials for packaging domestic appliances and construction materials. Additionally, they are also used as heat insulators for architecture because of their excellent heat insulation performance.

A skin-covered foamed molded article composed of an expanded beads foamed molded article and a skin (hollow molded article) that covers the foamed molded article is also known (see, for example, Japanese Kokai Publication No. JP-A-H6-328550). Such a skin-covered article may be produced by a method in which a hollow molded article is formed by blow molding from a parison of a polystyrene-based or polyolefin-based resin, the hollow space of the hollow molded article being subsequently filled with expanded beads such as polystyrene resin expanded beads. The expanded beads are then heated with a heating medium and fuse-bonded together to give the intended skin-covered foamed molded article. This article excels in lightness in weight, appearance and design and, further, in mechanical strength such as flexural rigidity and bending strength because of the tightly fuse-bonded expanded beads covered with the skin.

When the skin of the above-described skin-covered foamed molded article is constituted of a resin, for example a polystyrene-based resin, that is similar to the resin constituting the expanded beads, for example, polystyrene resin expanded beads, the skin-covered foamed molded article has improved mechanical strength such as flexural rigidity and bending strength because the skin is fuse-bonded to the expanded beads molded article. Such a skin-covered molded article having excellent mechanical properties lends itself to use for a bathroom ceiling material (see, for example, Japanese Kokai Publication No. JP-A-2010-46920).

### SUMMARY OF THE INVENTION

One particular use of the expanded beads foamed molded article is as an energy absorbing member for absorbing impact energy through bending deformation and compressive deformation thereof. The energy absorbing member may take various shapes and sizes and may be a small sized member such as an automobile bumper core and a tibia pad, or a large sized member such as a fender for ships. In either case, the energy absorbing member is required to sufficiently absorb impact energy in a limited stroke range.

When polystyrene-based resin expanded beads foamed molded article in which the expanded beads even in a deep inside region thereof are sufficiently fuse-bonded is used as an energy absorbing member that is expected to be greatly deformed upon collision, an excessively large reaction force is generated upon collision. When the fusion bonding is not sufficient, on the other hand, large deformation of the energy absorbing member results in failure and disintegration thereof. Therefore, in either case, it is likely that the desired energy absorbing performance cannot be achieved.

When a skin-covered foamed molded article is used as an energy absorbing member, on the other hand, breakage of the expanded beads foamed molded article which is covered with the skin does not result in disintegration of the energy absorbing member. However, even though the disintegration of the energy absorbing member can be avoided, the desired energy absorbing performance has been found to be no longer reproducibly achievable. Further, it has been found that when a known skin-covered foamed molded article is used as an energy absorbing member, the energy absorbing behaviors thereof quite differ between small scale energy absorption and large scale energy absorption. Namely, it is easy to investigate the energy absorbing behaviors of a small size energy absorbing member (in which the molded articles is used singly) by experiments. In the case of a large size energy absorbing member such as a fender for ships (in which a plurality of the molded articles are integrated), on the other hand, it is necessary to actually install the fender on the ship and to repeatedly conduct collision tests in situ in order to investigate the real energy absorbing behaviors thereof.

It is an object of the present invention to provide a skin-covered foamed molded article which is excellent in lightness and in energy absorbing performance and which can reproducibly exhibit its energy absorbing performance as designed even when it is used for constructing a large sized energy absorbing member.

Another object of the present invention is to provide an energy absorbing member which can absorb a great impact as designed.

In accordance with the present invention there are provided the following skin-covered foamed molded articles:

(1) a skin-covered foamed molded article comprising a polystyrene-based resin expanded beads molded article, and a skin covering a substantially entire surface of the expanded beads molded article, wherein said skin is formed of an olefinic thermoplastic elastomer and covers the expanded beads molded article in such a manner that the skin is in contact with the surface thereof but is unbonded thereto;
(2) the skin-covered foamed molded article according to above (1), wherein the expanded beads molded article has a voidage of 5% or less and a fusion bonding rate of 20 to 70%;
(3) the skin-covered foamed molded article according to above (1) or (2), wherein the expanded beads molded article has an apparent density of 15 to 50 kg/m³;
(4) the skin-covered foamed molded article according to any one of above (1) to (3), wherein the skin has an average thickness of 1 to 5 mm;
(5) the skin-covered foamed molded article according to any one of above (1) to (4), wherein the olefinic thermoplastic elastomer has a Durometer A hardness of 85 or less; and
(6) the skin-covered foamed molded article according to any one of above (1) to (5), wherein the skin is a blow-molded product and defines a hollow interior space therein and the expanded beads molded article is obtained by heating and fusion-bonding polystyrene-based resin expanded beads placed in said hollow interior space.

In a further aspect, the present invention provides:

(7) an energy absorbing member comprising a skin-covered foamed molded article according to any one of above (1) to (6).

The term “polystyrene-based resin” is hereinafter referred to simply as “PST”. The term “polystyrene-based resin expanded beads” is hereinafter referred to as “PST beads”. The term “polystyrene-based resin expanded beads molded article” is hereinafter referred to as “PST beads molding”.

### BRIEF DESCRIPTION OF THE DRAWINGS

Other objects, features and advantages of the invention will become apparent from the detailed description of the invention which follows, when considered in the light of the accompanying drawings, in which:

FIG. 1(a) is a perspective view schematically illustrating one embodiment of steam pin arrangement relative to mold halves that are brought together;

FIG. 1(b) is a front elevational view of FIG. 1(a);

FIG. 1(c) is a sectional view taken along the line B-B in FIG. 1(b);

FIG. 1(d) is a sectional view taken along the line A-A in FIG. 1(a);

FIG. 2(a) is a perspective view schematically illustrating another embodiment of steam pin arrangement relative mold halves that are brought together;

FIG. 2(b) is a sectional view taken along the line A1-A1 in FIG. 2(a); and

FIG. 2(c) is a sectional view taken along the line B1-B1 in FIG. 2(a).

### DETAILED DESCRIPTION OF THE INVENTION

The present invention relates to a skin-covered foamed molded article which includes a PST beads molding, and a skin that covers a substantially entire surface of the PST molding.

The skin-covered foamed molded article may be produced by first preparing a hollow molded article (skin) defining an interior space therein using any suitable molding method such as blow molding. PST beads are then filled in the hollow space of the skin and heated with a heating medium such as steam so that the PST beads are fuse-bonded to each other to form a PST beads molding within the skin.

It is important that the skin should be formed of an olefinic thermoplastic elastomer and should cover a substantially entire surface of the PST beads molding in such a manner that the skin is in contact with the surface of the PST beads molding but is unbonded to the PST beads molding for the following reasons.

When the skin is soft and flexible in nature and unbonded to the PST beads molding, the PST beads molding can be sufficiently deformed upon receipt of a collision impact and can absorb the impact energy. Further, the skin itself can independently absorb the impact energy. Therefore, the skin-covered foamed molded article as a whole can reproducibly exhibit its energy absorbing performance and permits the design of energy absorption characteristics of a large size energy absorbing member using the results obtained by a small scale experiment.

In addition, when the skin is in contact with the surface of the PST beads molding but is unbonded thereto, the PST beads molding can be bound by the skin in an adequate degree. Thus, upon receipt of collision impact energy, the PST beads molding, which is not excessively bound by the skin, can fully deform and absorb the impact energy sufficiently from the beginning of the collision. Moreover, the PST beads molding is not disintegrated and, therefore, can sufficiently exhibit energy absorbing characteristics even at the later stage of the collision. If the skin is bonded to the surface of the PST beads molding, the PST beads molding will fail to sufficiently deform and to reproducibly exhibit desired energy absorbing performance. If a gap or space is present between the skin and the PST beads molding, there is a possibility that a dimensional accuracy of the skin-covered foamed molded article will be deteriorated; an installation failure of the skin-covered foamed molded article will be caused; and the PST beads molding will be disintegrated upon being subjected to a relatively low impact stress.

As used herein, “the skin is in contact with the surface of the PST beads molding” is intended to mean that the skin and the PST beads molding are contacted to each other as close as possible such that a space, a gap or an air retaining area is not at all or substantially not present. One preferred method for achieving the state in which “the skin is in contact with the surface of the PST beads molding but is unbonded thereto” is to heat and fuse-bond PST beads that are filled in the interior space of the skin which in turn is placed in a mold cavity. In this case, it is preferred that the materials of which the skin and PST beads are constituted and the heating and fusing conditions are controlled so that the percent shrinkage of the skin is greater than that of the PST beads molding.

The skin covers a substantially entire surface of the PST beads molding. The term “substantially entire surface” herein is intended to mean that there may be a case in which a portion of the surface of the PST beads molding is not covered with the skin. Namely, a hole used for inserting a feed pipe for feeding PST beads to the interior space of the skin and/or small holes used for inserting steam pins for introducing steam into and discharging steam from the interior space of the skin generally remain present in the skin. Therefore, a portion of the surface of the PST beads molding may remain uncovered with the skin. A total area of such holes is generally at most 5% of the exterior surface area of the skin. In other words, the skin covers about 95% or more of the surface of the PST beads molding.

Whether or not the skin is unbonded to the PST beads molding may be determined by evaluating percent material failure of the PST beads molding when the skin-covered foamed molded article is subjected to a 90° peeling test between the skin and the PST beads molding. Thus, when the percentage material failure is not greater than 1%, the skin is regarded as being unbonded to the PST beads molding. The material failure is preferably 0%.

The peeling test is carried out as follows. A skin-covered foamed molded article is cut out to obtain a cubic test piece (having a size of 50 mm×50 mm×50 mm having the skin. A jig for measuring a peel strength is bonded with an adhesive to one side of the test piece which bears the skin, with another jig being bonded to a side opposite to the skin-bearing side. The test piece was then subjected to a tensile test in which the skin is peeled from the PST beads molding at a draw rate of 10 mm/minute using a tensile testing machine (Tensilon tensile tester). The surface of the PST beads molding after the skin has been peeled off is observed to count a number (C1) of the expanded beads present on the surface (inclusive of broken beads) and a number (C2) of the expanded beads that have been separated from the skin along the boundary between the skin and the PST molding without breakage of the beads. The percentage (C1−C2)/C1×100) is calculated as a material failure percentage of the test piece. Similar test is carried out 5 times in total and arithmetic mean is calculated. When the material failure percentage is 1% or less on average, the skin is regarded as being unbonded to the PST beads molding.

The constitution in which the skin is unbonded to the PST beads molding may be achieved by using an olefinic thermoplastic elastomer as a resin constituting the skin. The olefinic thermoplastic elastomer has no or little affinity with PST and the skin formed of the olefinic thermoplastic elastomer is not able to be fuse-bonded to the PST beads molding.

The PST beads molding may be obtained by heating and fuse-bonding PST beads.

The base resin of which the PST beads are constituted is PST which may be a homopolymer of styrenic monomer, a copolymer of two or more styrenic monomers, or a copolymer of at least 50% by weight of a styrenic monomer with less than 50% by weight of a comonomer that is not a styrenic monomer and is copolymerizable with the styrenic monomer.

Examples of the styrenic monomer include styrene, α-methylstyrene, o-methylstyrene, m-methylstyrene, p-methylstyrene, vinyltoluene, p-ethylstyrene, 2,4-dimethylstyrene, p-methoxystyrene, p-phenylstyrene, p-n-butylstyrene, p-n-hexyltoluene, p-octyltoluene, p-t-butylstyrene, o-chlorostyrene, m-chlorostyrene, p-chlorostyrene, 2,4-dichlorostyrene, 2,4,6-tribromostyrene, styrene sulfonic acid and sodium styrene sulfonate. Examples of comonomer copolymerizable with the styrenic monomer include C₁ to C₁₀ alkyl esters of acrylic acid such as methyl acrylate, ethyl acrylate, propyl acrylate, butyl acrylate and 2-ethylhexyl acrylate; C₁ to C₁₀ alkyl esters of methacrylic acid such as methyl methacrylate, ethyl methacrylate, propyl methacrylate, butyl methacrylate and 2-ethylhexyl methacrylate; and nitrile group-containing unsaturated compounds such as acrylonitrile and methacrylonitrile.

It is preferred that the PST contains a styrenic monomer members in an amount of 60 to 100% by weight, particularly preferably 70 to 100% by weight, for reasons of excellent foamability, excellent in-mold moldability of PST beads obtained therefrom and general purpose properties.

It is preferred that the PST beads molding has a voidage of 5% or less and a fusion bonding rate of 20 to 70%.

The skin-covered foamed molded article according to the present invention exhibits especially excellent energy absorbing performance when the substantially entire surface of the PST beads molding is covered with the skin and when the PST beads molding has a low voidage and a specific fusion bonding rate. A PST beads molding having a high voidage is likely to be brittle and to be low in absorbing a large energy. From this point of view, the voidage is preferably 3% or less, more preferably 1% or less.

When the fusion bonding rate of the PST beads molding is excessively high, a large reaction force is likely to be generated upon collision. Further, when a large volume PST beads molding having a low voidage between expanded beads is to be produced, an increase of the fusion bonding rate tends to cause shrinkage of the obtained PST beads molding. Thus, when the fusion bonding rate is excessively high, the PST beads molding will excessively shrink after having been produced. This may result in formation of a gap between the skin and PST beads molding and, therefore, the skin-covered foamed molded article may fail to exhibit the desired energy absorbing performance. From this point of view, the bonding rate of the PST beads molding is preferably 50% or less, more preferably 40% or less.

A PST beads molding, which is not covered with a skin and which has a low fusion bonding rate, will be easily broken even when subjected to a small strain and, therefore, fails to show desired energy absorbing performance. On the other hand, because the PST beads molding is covered and is in close contact with the skin having a specific constitution, the PST beads molding is not easily broken upon being deformed by collision even though the fusion-bonding rate is relatively low. Therefore, the skin-covered foamed molded article shows the desired energy absorbing performance.

As used herein, the “voidage” of the PST beads molding is determined as follows. A cubic sample is cut out of the PST beads molding that has been placed in an environment at a temperature of 23° C. and a relative humidity of 50% for at least 24 hours. From the external dimension of the sample, a bulk volume Va [cm³] thereof is determined. The sample is immersed in ethanol contained in a graduated measuring cylinder using a metal wire. From a rise of the liquid level, a true volume Vb [cm³] of the sample is determined. The voidage of the PST beads molding may be calculated from the true volume Vb [cm³] and bulk volume Va [cm³] by the following formula.

Voidage (%)=[(Va−Vb)/Va]×100

Similar measurement is carried out for a total of five samples from the same PST beads molding and an average of the obtained five voidage values is used as the voidage of the PST beads molding.

As used herein, the “fusion bonding rate” is measured by the following method. The PST beads molding is broken and the broken surface in which at least 100 expanded beads are present is observed with naked eyes to count the number (n1) of broken expanded beads (intra-bead separation) and the number (n2) of expanded beads separated along an interface between the expanded beads (inter-bead separation). The percentage (100×n1/(n1+n2)) of the number of the broken expanded beads (n1) to the sum of the number of broken expanded beads (n1) and the number of expanded beads separated along an interface between the expanded beads (n2) represents the fusion bonding rate.

The PST beads molding preferably has an apparent density of 15 to 50 kg/m³ for reasons of excellency in absorbing a large energy. From this point of view, the lower limit of the apparent density is more preferably 20 kg/m³. The more preferred upper limit of the apparent density is 40 kg/m³.

The skin should be constituted of an olefinic thermoplastic elastomer. If a thermoplastic resin with a relatively high rigidity, such as a high density polyethylene, a polypropylene-based resin and a polystyrene-based resin, is used for forming the skin, deformation of the PST beads molding upon being subjected to a collision impact is inhibited and, therefore, it is likely that the skin-covered foamed molded article is unable to exhibit sufficient energy absorbing properties or to achieve an energy absorbing performance as designed.

Examples of the olefinic thermoplastic elastomer include an elastomer that is composed of a matrix of polyolefin, such as polypropylene, and an olefin rubber component such as ethylene-propylene rubber, finely dispersed in the matrix; and an elastomer that is composed of a copolymer of ethylene, propylene and other α-olefin. The olefinic thermoplastic elastomer is elastic at room temperature, exhibits rubber elasticity and yet is able to be molded similar to the general thermoplastic resins.

Specific examples of the olefinic thermoplastic elastomer include “ESPOLEX TPE” (manufactured by Sumitomo Chemical Co., Ltd.), “THERMOLAN” and “ZELAS” manufactured by Mitsubishi Chemical Corporation, “MIRASTOMER” Mitsui Chemicals, Inc., “JSR EXCELINK” manufactured by JSR Corporation and “SARLINK” manufactured by Toyobo Co., Ltd.

The olefinic thermoplastic elastomer preferably has a Durometer A hardness of 85 or less, which means that the skin is soft. The PST beads molding covered with such a soft elastomer skin is more unlikely to be prevented from deforming upon receipt of collision impact. From this point of view, the Durometer A hardness of the olefinic thermoplastic elastomer is more preferably 82 or less, sill more preferably 80 or less. The lower limit of the Durometer A hardness is generally 30, preferably 45.

As used herein, the Durometer A hardness is as measured by Type A Durometer Hardness Test according to JIS K6253-3(2012) at 23° C.

When the skin of the skin-covered foamed molded article is produced by blow molding, it is preferred that the olefinic thermoplastic elastomer has MFR of 5.0 g/10 min or less, more preferably 4.0 g/10 min or less, particularly preferably 3.0 g/10 min or less. The lower limit of MFR is generally 0.1 g/10 min. The MFR of the olefinic thermoplastic elastomer is measured at 230° C. and a load of 5 kg.

The skin preferably has an average thickness of 5 mm or less since the PST beads molding covered with the skin is more unlikely to be prevented from deforming upon receipt of collision impact. The lower limit of the average thickness is generally about 1 mm when the skin is produced by blow molding.

The average thickness of the skin is measured as follows. First, on the skin-covered foamed molded article, 10 or more measuring points are randomly selected (portions, such as corner portions, having a thickness quite different from other portions are excluded) for measuring the skin thickness. At each of the measuring points, the skin-covered foamed molded article is cut, and the cross-section is measured for the thickness of the skin using a thickness gauge. Alternatively, the skin at each of the measuring points is cut off, and the cut skin is measured for its thickness using a thickness gauge. The average thickness of the skin is an arithmetic mean of the measured values. If the boundary between the skin and the PST beads molding is so unclear that it is difficult to determine the thickness using the thickness gauge, the thickness measurement may be carried out using an ultrasonic thickness gauge without cutting the skin-covered foamed molded article.

The skin-covered foamed molded article has a constitution in which the substantially entire surface of the PST beads molding is covered and in contact with the skin formed of an olefinic thermoplastic elastomer but is unbonded to the skin. As a result of such a constitution, the skin-covered foamed molded article, when subjected to a great collision impact, shows a strain-stress curve in which the stress rapidly increases at an initial stage of the impact but does not excessively increase thereafter. Thus, the impact energy in the initial stage of the collision can be efficiently absorbed. Further, even in the case of a great deformation, the energy can be absorbed without an excessive increase of the stress.

Additionally, since the PST beads molding is covered with the skin formed of an olefinic thermoplastic elastomer, the skin-covered foamed molded article has excellent appearance, dimensional stability, weatherability and resistance to chemicals.

Accordingly, the skin-covered foamed molded article of the present invention can be suitably employed as an energy absorbing member that is required to absorb massive impact energy, such as a large ship fender having a volume of more than 100 L.

It is preferred that the skin-covered foamed molded article of the present invention, when subjected to a bending test, shows an initial load ratio (F₅/F₂) of the load F₅ at a deflection of 5 mm to the load F₂ at a deflection of 2 mm of at least 1.5, more preferably at least 2.0. When the substantially entire surface of the PST beads molding is in contact with and covered with the skin formed of an olefinic thermoplastic elastomer while preventing a gap or space from forming therebetween, the initial load ratio of at least 1.5 may be achieved. The upper limit of the initial load ratio (F₅/F₂) is generally 5, preferably 3.

The bending test is a three-point bending test according to JIS K7221-2(2006).

It is also preferred that the skin-covered foamed molded article of the present invention when subjected to a compressive test, shows a ratio (C₂₅/C₅) of the compressive stress C₂₅ at 25% compression to the compressive stress C₅ at 5% compression of 0.3 to 2.5, more preferably 0.4 to 1.0 and also shows a ratio (C₅₀/C₂₅) of the compressive stress C₅₀ at 50% compression to the compressive stress C₂₅ at 25% compression is 1.2 to 2.0. The skin-covered foamed molded article that shows the above energy absorbing characteristics (namely that gives a strain-stress (S-S) curve with a rectangular wave form) exhibits particularly excellent energy absorbing performance.

The above compressive test is carried out according to JIS K7220(2006).

For reasons of excellency in production efficiency, the skin-covered foamed molded article is preferably produced by a method including first preparing a skin by blow molding, then filling PST beads in the skin and thereafter heating the PST beads to fuse-bond the PST beads together and to foam a PST beads molding in the skin.

The above method will be described in detail below. It should be noted, however, the skin-covered foamed molded article may be produced without resorting to use of blow molding.

A parison, in a softened state, extruded from an extruder is placed between split mold halves located just beneath the extruder. The mold halves are then closed around the parison and air is introduced into the parison to conform it to the shape of the mold cavity defined by the mold halves, thereby obtaining a molded article (skin) defining a hollow interior space therein. A plurality of heating medium feeding and discharging pins each provided with a plurality of gas inlet/outlet ports are inserted through the skin into the interior space thereof. Then, PST beads are filled in the space of the skin. A heating medium such as steam is fed into and discharged from the skin through the pins to heat and fuse-bond the PST beads together and to form a PST beads molding covered with the skin. The mold halves are opened to take the thus produced skin-covered foamed molded article out of them. Each of the pins is usable for feeding or discharging the heating medium.

A method of forming the PST beads molding within the skin using steam as the heating medium will be described in detail below. PST beads filled in the space of the skin are heated with steam which is introduced thereinto and discharged therefrom through a plurality of heating medium feeding/discharging pins (hereinafter referred to simply as steam pins). The steam pins are generally divided into two first and second groups each including the same number of steam pins. The heating of the PST beads with steam may be carried out by a one-direction flow heating method, in which steam is fed into the skin only through the first group of steam pins and discharged from the skin only through the second group of steam pins. The heating of the PST beads with steam may be also carried out by an alternate flow heating method in which, in a first period of heating, steam is supplied to the first group of steam pins while discharging the steam through the second group of steam pins and, in the next period of heating, steam is supplied to the second group while discharging steam from the first group. Such a flow reversal may be repeated one or more times as desired. In order to evenly heat the PST beads contained in the skin, the alternate flow heating method is preferred.

In general, high pressure steam is supplied to a steam chamber where it is adjusted to a desired pressure. The steam with an adjusted pressure is then supplied to the selected steam pins inserted into the skin and is brought into contact with the PST beads to fuse-bond the PST beads.

The positions and directions of the steam pins inserted into the skin are not specifically limited but are preferably determined in view of the shape of the skin such that the PST beads within the skin are evenly heated with steam introduced through the steam pins. If it is desired, from the standpoint of aesthetics, to minimize the presence of the traces of holes formed as a result of insertion of the steam pins through the skin, the steam pins are inserted through the skin in as small a number of directions as possible, preferably in one or two directions.

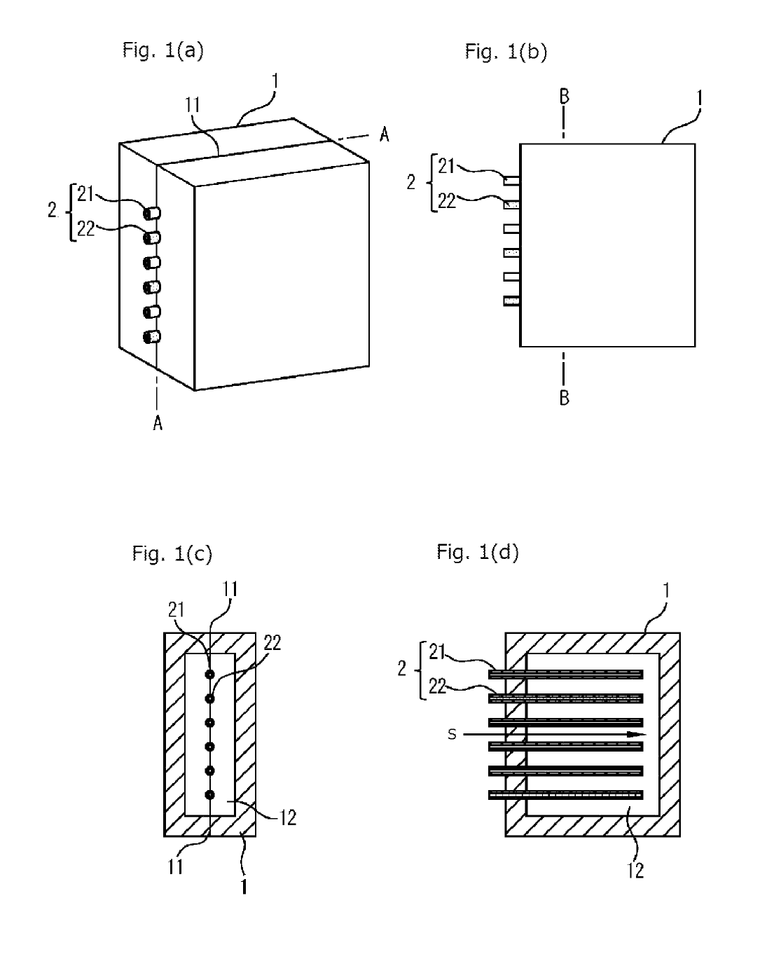

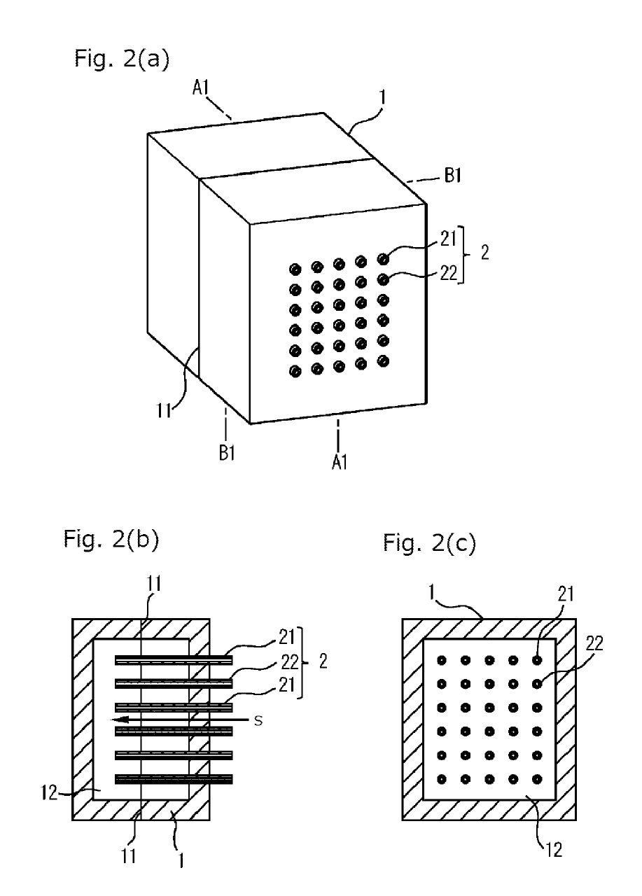

FIG. 1(a) to FIG. 1(d) and FIG. 2(a) to FIG. 2(c) schematically depict examples of the arrangement of steam pins. In these Figures, designated as 1 is a mold having mold halves that are abutted at a parting line 11 to define a mold cavity 12. A plurality of steam pins 2 are inserted into the skin in the same direction as best seen in FIG. 1(d) and FIG. 2(b) from one side of the mold 1 (a side which includes the parting line 11 in the case of FIG. 1(a) and a side which does not include the parting line 11 in the case of FIG. 2(a)). The steam pins 2 include a first group of steam pins (three steam pins 21 in the case of FIG. 1(a) and fifteen steam pins 21 in the case of FIG. 2(a)) and a second group of steam pins (three steam pins 22 in the case of FIG. 1(a) and fifteen steam pins 22 in the case of FIG. 2(a)). The insertion direction S of the steam pins 2 is not limited to the one direction as in the illustrated embodiments and may be, for example, two directions (opposing directions), if desired.

In the embodiment of FIG. 1(a) to FIG. 1(d), the six steam pins 2 are arrayed in a single line with adjacent steam pins belonging to different groups.

In the embodiment of FIG. 2(a) to FIG. 2(c), the steam pins 2 are arranged in five parallel columns in the lengthwise direction of the mold cavity and six parallel rows in the widthwise direction of the mold cavity with each column consisting of six equally spaced apart steam pins. The thirty steam pins are arranged in such a way that five steam pins in each row belong to the same group while adjacent two steam pins in each column belong to the different groups. It is without saying that the arrangement of the steam pins is not limited to the above. For example, the thirty steam pins may be arranged in such a way that six steam pins in each column belong to the same group while adjacent two steam pins in each row belong to the different groups. Further, the steam pins may be arranged in such a way that adjacent steam pins in each row and adjacent steam pins in each column belong to the different groups, so that the steam pins in the same group are arranged in a staggered pattern.

In order to minimize variation of fusion bonding between PST beads of the PST beads molding, it is preferred that each of the steam pins for use in feeding steam is spaced apart a distance (pitch) of 400 mm or less from its adjacent steam pin for use in discharging steam. As the pitch between the steam pin for use in feeding steam and the steam pin for use in discharging steam becomes smaller, the variation in fusion bonding of the PST beads molding reduces. Therefore, the pitch is more preferably 350 mm or less, still more preferably 300 mm or less.

As the pitch becomes smaller, however, the number of the undesirable traces of holes formed as a result of insertion of the steam pins through the skin generally increases. For this reason, the pitch between the steam pin for use in feeding steam and the steam pin for use in discharging steam is preferably 150 mm or more.

The heating and fusion bonding of the PST beads within the skin is preferably carried out in such a way that the obtained PST beads molding has a voidage of 5% or less and a fusion bonding rate of 20 to 70%. To this end, the pressure of steam is desired to be adjusted in the above-mentioned steam chamber to 0.05 to 0.3 MPaG (gauge pressure), more preferably to 0.10 to 0.18 MPaG.

Steam intlet/outlet ports in each of the steam pins may be provided in any desired location and arrangement. For example such ports may be formed only in a periphery thereof when the steam pins are inserted through the skin in the same direction. When the steam pins are inserted from two opposite directions, the steam inlet/outlet ports may be formed not only in peripheral portions thereof but also in distal tip ends thereof.

The steam pins preferably have an inside diameter of 2 to 8 mm, more preferably 2 to 6 mm, for reasons of easiness in controlling the feed rate, discharge rate and flow rate of steam. The outer diameter of the steam pins is preferably 15 mm or less, more preferably 10 mm or less, since excessively large outer diameter of the steam pins may result in the formation of traces of insertion holes and may adversely affect the aesthetics and impact resistance of the obtained skin-covered foamed molded article.

As described previously, it is preferred that the percent shrinkage of the skin is greater than that of the PST beads molding in order to easily attain the contact between the skin and the PST beads molding. The percentage shrinkage of the PST beads molding may be controlled by control of the secondary expansion efficiency of the PST beads. For example, the skin having a percentage shrinkage of 1.5% or less can be properly in contact with the PST beads molding, when the PST beads molding has been produced from the PST beads containing a blowing agent in an amount of preferably 100 to 400 g, more preferably 150 to 350 g, still more preferably 200 to 300 g, per 1 m³ of the PST beads.

The content of the blowing agent in the PST beads is as determined by a method in which the PST beads are heated in an oven at 120° C. for 30 minutes to dissipate the blowing agent contained therein. From the weight loss, the content of the blowing agent is calculated. The oven may be a gear oven (Model GPH-200 manufactured by Tabai Espec Corporation).

It is preferred that PST beads are coated with a coating agent such as liquid paraffin, glycerin diacetate monolaurate, glycerin tristearate, di-2-ethylhexyl phthalate and di-2-ethylhexyl adipate in order to improve secondary expansion efficiency and fusion bonding efficiency thereof and to control the percentage shrinkage of PST beads molding obtained therefrom. Such coated PST beads may be obtained by pre-expanding expandable PST particles covered with the coating agent or by mixing pre-expanded PST particles with the coating agent.

The PST beads molding with a preferable apparent density of 15 to 50 kg/m³ may be suitably obtained by using PST beads having a bulk density of 15 to 50 kg/m³.

The PST beads may be prepared by any known method. One suitable method includes dispersing a styrenic monomer such as styrene with stirring in an aqueous medium contained in a closed vessel in the presence of a suspending agent to suspension polymerize the monomer. During or after the suspension polymerization, a blowing agent, such as an aliphatic hydrocarbon, and other additives such as a plasticizer are added to obtain expandable PST particles. The obtained expandable PST particles are heated, foamed and expanded to obtain PST beads.

Any customarily employed blowing agent may be used for producing the PST beads. Examples of the blowing agent include saturated hydrocarbons such as propane, n-butane. i-butane, n-pentane, i-pentane, neopentane and cyclopentane; chlorinated hydrocarbons such as methyl chloride and ethyl chloride; and inorganic gases such as air, carbon dioxide and nitrogen. For reasons of easiness in controlling the amount of the blowing agent in the PST beads, the saturated hydrocarbons are preferred.

The following examples and comparative examples will further illustrate the present invention. It should be noted that the present invention is not limited to the examples.

The grade names, manufacturers and physical properties of the materials used for forming skins are shown in Table 1 and the kinds of the base resins and physical properties of PST beads are shown in Table 2.

TABLE 1

| | | | | | Percentage | |
|---|---|---|---|---|---|---|
| | | | | Durometer A | shrinkage | MFR |
| Abbreviation | Kind | Manufacturer | Grade name | hardness | (%) | (g/10 min) |
| TPO1 | Olefinic thermopastic | Sumitomo | ESPOLEX 820 | 78 | 0.8 | 2.3 |
| | elastomer | Chemical Co., | | | | |
| | | Ltd. | | | | |
| TPO2 | Olefinic thermopastic | Sumitomo | ESPOLEX 4675 | 60 | 1.0 | 0.4 |
| | elastomer | Chemical Co., | | | | |
| | | Ltd. | | | | |
| HDPE | High density polyethylene | Asahi Kasei | SUNTEC-HD B680 | >90 | 2.4 | not measured |
| | | Chemicals | | | | |
| | | Corporation | | | | |
| HI/GP | Impact resisting | PS Japan | PSJ-polystyrene H0104/ | >90 | 0.6 | not measured |
| | polystyrene/general purpose | | PSJ-polystyrene G9401 | | | |
| | polystyrene 60/40 | | | | | |

TABLE 2

| | | Bulk density | Content of blowing agent |
|---|---|---|---|
| Abbreviation | Base resin | (kg/m³) | (g/m³) |
| PST beads 1 | Polystyrene | 21 | 260 |
| PST beads 2 | Acrylonitrile- | 25 | 280 |
| | styrene | | |
| | copolymer | | |
| PST beads 3 | Polystyrene | 21 | 60 |

### Preparation of PST Beads 1

Expandable PST particles constituted of polystyrene as a base resin and containing, as a blowing agent, 1.6% by weight of butane and 1.4% by weight of cyclohexane were pre-expanded at a temperature of 102° C. to obtain PST beads 1 having a bulk density of 21 kg/m³ and an average particle diameter of 3.1 mm. The PST beads 1 were allowed to stand at room temperature so that their blowing agent content was adjusted to the value shown in Table 2. The average diameter of the PST beads herein is determined as follows. One hundred (100) arbitrarily-selected expanded beads are each measured for its maximum diameter and the average of the measured maximum diameters is defined as the average diameter of the expanded beads.

### Preparation of PST Beads 2

Expandable PST particles constituted of an acrylonitrile-styrene copolymer as a base resin and containing, as a blowing agent, 2.8% by weight of butane and 2.3% by weight of cyclohexane were pre-expanded at a temperature of 102° C. to obtain PST beads 2 having a bulk density of 25 kg/m³ and an average particle diameter of 3.0 mm. The PST beads 2 were allowed to stand at room temperature so that their blowing agent content was adjusted to the value shown in Table 2.

### Preparation of PST Beads 3

Expandable PST particles constituted of polystyrene as a base resin and containing, as a blowing agent, 1.6% by weight of butane and 1.4% by weight of cyclohexane were pre-expanded at a temperature of 102° C. to obtain PST beads 3 having a bulk density of 21 kg/m³ and an average particle diameter of 3.1 mm. The PST beads 3 were allowed to stand at room temperature so that their blowing agent content was adjusted to the value shown in Table 2.

### Example 1

The olefinic thermoplastic elastomer TPO1 shown in Table 1 was heated and kneaded at 190° C. in an extruder having an inside diameter of 65 mm to prepare a melt of the resin. The melt was then filled in an accumulator attached to the extruder and adjusted to 190° C. The melt was then extruded through a die, and the resulting parison in a softened state was placed between mold halves of a dividable flat plate-like mold located immediately below the die. The mold was closed and adjusted to 50° C. Then, a blow pin was inserted into the parison and pressurized air with a pressure of 0.50 MPa(G) was blown into the parison through the blow pin. At the same time, the space between the outer surface of the parison and the inner surface of the mold was evacuated to form a hollow blow-molded product (skin defining a hollow interior space) conforming to the shape of the mold cavity. The mold halves when brought together defined a mold cavity having a length of 150 mm, a width of 150 mm and a thickness of 100 mm. The mold was provided with an expanded beads filling feeder (diameter: 18 mm) and two steam pins (diameter: 8 mm) spaced apart a pitch of 170 mm and each provided with slit-like steam inlet/outlet ports.

The two steam pins and the filling feeder were inserted through the skin from a side of one of the mold halves toward opposing side of the other mold half. Then the PST beads 1 having a bulk density of 21 kg/m³ and an average particle diameter of 3.1 mm were fed through the filling feeder into the hollow interior space of the skin while venting the air therefrom through the inlet/outlet ports. After the PST beads 1 had been filled in the skin, steam having a pressure shown in Table 3 (0.14 MPa(G)) was fed through one of the steam pin into the skin for 10 seconds while sucking the steam from the other steam pin. Then the steam flow direction was reversed by feeding steam having a pressure shown in Table 3 (0.14 MPa(G)) from the other steam pin for 10 seconds while sucking the steam from the one steam pin. The mold halves were then cooled and opened to obtain a skin-covered foamed molded article. The molding cycle time from the start of blow molding the skin to the taking of the skin-covered foamed molded article out of the mold was as shown in Table 3. The steam pressure is the pressure in a steam chamber from which the steam is fed to the steam pin.

### Example 2

A skin-covered foamed molded article was produced in the same manner as described in Example 1 except that the PST beads 2 were substituted for the PST beads 1 and molded under the conditions shown in Table 3.

### Example 3

A skin-covered foamed molded article was produced in the same manner as described in Example 1 except that the olefinic thermoplastic elastomer TPO2 shown in Table 1 was used in lieu of TPO1 for forming the skin.

### Comparative Example 1

A skin-covered foamed molded article was produced in the same manner as described in Example 1 except that the PST beads 3 were substituted for the PST beads 1 and molded under the conditions shown in Table 3. Because a gap was formed between the skin and the PST beads molding, the PST beads molding was broken in an early stage of compressive test. Thus, the skin-covered foamed molded article was poor in energy absorbing characteristics.

### Comparative Example 2

A skin-covered foamed molded article was produced in the same manner as described in Example 1 except that the HI/GP shown in Table 1 was used in lieu of TPO1 for forming the skin and that the melt of HI/GP was adjusted in the accumulator to a temperature of 185° C. The HI/GP was a blend of 40 parts by weight of impact resisting polystyrene (trade name: PSJ-Polystyrene, grade name: H0104, manufactured by PS Japan) and 60 parts by weight of general purpose polystyrene (trade name: PSJ-Polystyrene, grade name: G9401, manufactured by PS Japan). The skin, which was constituted of PST, is fuse-bonded to the PST beads molding. Therefore, the obtained skin-covered foamed molded article showed a very high compressive stress in an initial stage of the compressive test. Additionally, the PST beads molding, which was excessively bound by the skin, was broken in an initial stage of the compressive test. Thus, the skin-covered foamed molded article was poor in energy absorbing characteristics.

### Comparative Example 3

A skin-covered foamed molded article was produced in the same manner as described in Example 1 except that the HDPE shown in Table 1 was used in lieu of TPO1 for forming the skin and that the melt of HDPE was adjusted in the accumulator to a temperature of 230° C. Because the skin was constituted of high density polyethylene, the obtained skin-covered foamed molded article showed a very high compressive stress in an initial stage of the compressive test, although the skin was unbonded to the PST beads molding. Additionally, the PST beads molding was not bound by the skin and, therefore, was broken in an initial stage of the compressive test. Thus, the skin-covered foamed molded article was poor in energy absorbing characteristics.

The molding conditions used in the Examples and Comparative Examples are summarized in Table 3.

TABLE 3

| | | | Steam | Percentage | |
|---|---|---|---|---|---|
| | | | pressure | shrinkage of | Molding |
| | | | (MPa | PST beads | cycle time |
| | Skin | PST beads | (G)) | molding (%) | (sec) |
| Example 1 | TPO1 | PST beads 1 | 0.14 | 0.6 | 210 |
| Example 2 | TPO1 | PST beads 2 | 0.14 | 0.6 | 240 |
| Example 3 | TPO2 | PST beads 1 | 0.14 | 0.6 | 210 |
| Comparative | TPO1 | PST beads 3 | 0.20 | 3.5 | 220 |
| Example 1 | | | | | |
| Comparative | HI/GP | PST beads 1 | 0.14 | 0.6 | 230 |
| Example 2 | | | | | |
| Comparative | HDPE | PST beads 1 | 0.14 | 0.6 | 250 |
| Example 3 | | | | | |

The skin-covered foamed molded articles obtained in the examples and comparative examples had physical properties shown in Tables 4 and 5.

TABLE 4

| | Skin | | PST beads molding | | | Skin-covered foamed molded article | | |
|---|---|---|---|---|---|---|---|---|
| | | Average | Apparent | | Fusion | Gap between skin | Bonding between skin | |
| | | thickness | density | Voidage | bonding | and PST beads | and PST beads | Surface |
| | Kind | (mm) | (kg/m³) | (%) | rate (%) | molding | molding | smoothness |
| Example 1 | TPO1 | 2 | 21 | 1.5 | 30 | none | none | good |
| Example 2 | TPO1 | 2 | 25 | 1.2 | 25 | none | none | good |
| Example 3 | TPO2 | 2 | 21 | 1.5 | 30 | none | none | good |
| Comparative | TPO1 | 2 | 24 | 1.2 | 50 | present | none | poor |
| Example 1 | | | | | | | | |
| Comparative | PST | 2 | 21 | 1.5 | 30 | none | bonded | good |
| Example 2 | | | | | | | | |
| Comparative | HDPE | 2 | 21 | 1.5 | 30 | none | none | good |
| Example 3 | | | | | | | | |

TABLE 5

| | Compressive test | | | | | | | |
|---|---|---|---|---|---|---|---|---|
| | | | | Total energy | Strain at | | | |
| | C₅ | C₂₅ | C₅₀ | absorption | failure | | | Bending test |
| | kPa | kPa | kPa | kJ/m³ | % | C₂₅/C₅ | C₅₀/C₂₅ | F₅/F₂ |
| Example 1 | 380 | 230 | 300 | 165 | more than | 0.61 | 1.30 | 2.35 |
| | | | | | 60 | | | |
| Example 2 | 390 | 250 | 320 | 172 | more than | 0.64 | 1.28 | 2.50 |
| | | | | | 60 | | | |
| Example 3 | 330 | 220 | 270 | 148 | more than | 0.67 | 1.23 | 2.35 |
| | | | | | 60 | | | |
| Comparative | 130 | — | — | (47) | 20 | — | — | 1.25 |
| Example 1 | | | | | | | | |
| Comparative | 700 | — | — | (59) | 10 | — | — | 3.33 |
| Example 2 | | | | | | | | |
| Comparative | 500 | 30 | — | (81) | 25 | 0.06 | — | 1.75 |
| Example 3 | | | | | | | | |

The physical properties shown in Tables 1 to 5 were measured and evaluated as follows.

### Durometer A Hardness:

Durometer A hardness was measured by the method described above.

### Content of Blowing Agent:

The amount of a blowing agent contained in PST beads was measured from a change in weight of the PST beads. A gear oven (Model GPH-200 manufactured by Tabai Espec Corporation) was used. About 2 g of PST beads were sampled and measured for the weight W1 [g] thereof to the fourth decimal place. The sample was then placed in the oven at 120° C. for 30 minutes. Thereafter, the sample was again measured to determine the weight W2 [g] thereof to the fourth decimal place. From the weight loss (W1−W2), the content [g/kg] of the blowing agent per 1 kg of the PST beads was calculated from (W1−W2)/(1000×W1). This was multiplied by the apparent density D [kg/m³] of the PST beads to obtain the amount of the blowing agent [g/m³] contained in 1 m³ of the PST beads ((W1−W2)×D/(1000×W1)). Similar measurement was carried out 5 times in total and the arithmetic mean of the five measured values was used as the blowing agent content of PST beads.

### Bulk Density of PST Beads:

PST beads (weight: W [g]) were immersed using a wire net in water contained in a measuring cylinder. From the rise of the water level, the volume (V [L]) of the PST beads was determined. The weight W was divided by the volume L, and the resulting value W/L (apparent density) was further divided by 1.6 to give a bulk density (W/L)/1.6 [g/L] of the PST beads. The member of the bulk density was then converted into [kg/m³].

### Percentage Shrinkage of PST Beads Molding:

PST beads 1, 2 and 3 were molded in the mold cavity under the same conditions as those employed in the corresponding Examples and Comparative Examples except that blow molding was not carried out, thereby obtaining PST beads moldings having no skin. The length d [mm] of each PST beads molding which corresponded to the length (150 mm) of the mold cavity was measured. The percentage shrinkage of the PST beads molding was calculated from the following equation:

Percentage shrinkage (%)=[(150−d)/150]×100

### Percentage Shrinkage of Skin:

Parisons of TPO1, TPO2, HI/GP and HDPE were prepared and blow-molded under the same conditions as those in the corresponding Examples and Comparative Examples to obtain hollow molded articles (skins) having no PST beads moldings. Insertion of steam pins, feed of expanded beads into the hollow molded articles were not carried out. The length ds [mm] of each skin which corresponded to the length (150 mm) of the mold cavity was measured. The percentage shrinkage of each skin was calculated from the following equation:

Percentage shrinkage (%)=[(150−ds)/150]×100

### Gap Between Skin and PST Beads Molding:

The obtained skin-covered foamed molded article was cut and the cross-section was observed with naked eyes to determine whether or not a gap was present between the skin and PST beads molding. In Table 4, “none” indicates that no gap is present, while “present” indicates that a gap is present.

### Bonding Between Skin and PST Beads Molding:

The peeling test in which the skin was peeled off from the PST beads molding was carried out in the manner described previously. In Table 4, “none” indicates that the material failure percentage is zero, “slight” indicates that the material failure percentage is greater than 0 and is not greater than 1%, and “bonded” indicates that the material failure percentage exceeds 1%.

### Average Thickness of Skin:

The average thickness of the skin was measured as follows. First, on each of the opposing surfaces of the skin-covered foamed molded article, which surfaces had a length of 150 mm and width of 150 mm, 10 measuring points were randomly selected. The skin at each of the 20 measuring points was cut off from the skin-covered foamed molded article, and the cut skin was measured for its thickness using a thickness gauge. The arithmetic mean of the 20 measured values represents the average thickness [mm] of the skin.

### Voidage:

The voidage of the PST beads molding was measured by the previously described method.

### Fusion Bonding Rate:

The fusion bonding rate of the PST beads molding was measured as follows. From nearly a central part the skin-covered foamed molded article, a rectangular parallelepiped plank of the PST beads molding with a length of about 150 mm, a width of 75 mm and a thickness of 25 mm was cut out in such a way that no skin was included in the obtained plank. In one of the two largest surfaces (with a length of about 150 mm and a width of 75 mm) of the plank, a cut having a depth of 2 mm and extending near the longitudinal center and across the entire width of the plank was formed, thereby to obtain a test piece which was weakened in the cut line. The test piece was then bent and allowed to be broken along the cut line in accordance with 3-point bending test as referenced in JIS K7221-2(2006) under conditions with a distance of 70 mm between fulcrums and a pressure wedge speed (crosshead speed) of 200 mm/min. The broken surface was then observed with naked eyes to count the number (n1) of broken expanded beads (intra-bead separation) and the number (n2) of expanded beads separated along an interface between the expanded beads (inter-bead separation). The percentage of the number of the broken expanded beads to the sum of the number of broken expanded beads and the number of expanded beads separated along an interface between the expanded beads was calculated as the fusion bonding rate. In the above measurement, the expanded beads that were present on the 2 mm cut region were ignored and not included in the counts n1 and n2.

### Compressive Test (5% Compressive Stress C₅, 25% Compressive Stress C₂₅ and 50% Compressive Stress C₅₀):

According to JIS K7220(2006), a sample (size: 150×150×100 mm) of each of the obtained skin-covered foamed molded articles was subjected to a compressive test at a test speed of 40 mm/min to obtain a stress-strain curve. From the stress-strain curve, 5% compressive stress C₅, 25% compressive stress C₂₅ and 50% compressive stress C₅₀ were determined. Additionally, the stress-strain curve was integrated from 0 to 60% compression to determine the energy absorption [kJ]. This energy absorption was divided by the volume [m³] of the sample to obtain a total energy absorption EA [kJ/m³] which shows a total energy absorbed by the sample until a compression of 60% was reached. In the case where the PST beads molding had been broken before a compression of 60% was reached, the energy absorbed by the PST beads molding until failure is shown with parenthesis “( )” in Table 5. When the PST beads molding is broken, the compression stress abruptly decreases. The strain [%] at which the compression stress abruptly decreased is shown in Table 5 as “strain at failure” of the PST beads molding. In Table 5, the symbol “-” indicates that the compression stress was unable to be measured because of the breakage of the PST beads molding.

### Bending Load Ratio F₅/F₂:

Each of the obtained skin-covered foamed molded articles was subjected to a three-point bending test as referenced in JIS K7221-2(2006) with a test speed of 20 mm/min and a span of 100 mm to determine its bending load F₂ at a deflection of 2 mm and bending load F₅ at a deflection of 5 mm.

### Surface Smoothness:

Surface smoothness of each of the obtained skin-covered foamed molded articles was evaluated based on the following criteria:

good: The molded article has a shape conforming to the shape of the mold cavity and is free of unevenness.

poor: The molded article has a portion in which the skin is raised or the molded article has significant unevenness.

### Example 4

A rectangular parallelepiped skin-covered foamed molded article was produced using the same materials (olefinic thermoplastic elastomer TPO1 and PST beads 1) as those used in Example 1. The skin (hollow molded article) was produced by blow molding in a mold cavity having a length of 1,080 mm, a width of 800 mm and a thickness of 410 mm. The PST beads 1 were molded within the skin using 16 steam pins arranged in rows and columns. Each row consisted of four steam pins regularly arrayed in the widthwise direction of the mold cavity with a pitch of 150 mm, while each column consisted of four steam pins regularly arrayed in the lengthwise direction of the mold cavity with a pitch of 200 mm. The PST beads molding of the obtained skin-covered foamed molded article had an apparent density of 21 kg/m³, a voidage of 1.5% and a fusion bonding rate of 30%. The skin of the skin-covered foamed molded article had an average thickness of 2 mm and was in close contact with the PST beads molding without being bonded thereto.

Eight such skin-covered foamed molded articles were prepared and fixed to a front side of a structural body in such a manner that they were stacked in their thickness direction with their lengthwise directions being in parallel with the collision direction of the structural body. The weight of the whole structural body inclusive of the eight molded articles was 6t.

The structural body provided with the molded articles was caused to collide at a speed of 10 m/s against a solid wall and measured for the acceleration at a central portion on the front side of thereof using an acceleration sensor. As the sensor, Triaxial Acceleration Transducer (Model AS-TB50, manufactured by Kyowa Electronic Instruments Co., Ltd.) was used. The acceleration at the central portion on the front side of the structural body was 12.77 G. Separately, the acceleration at a time of collision, at a speed of 10 m/s, of the front side of the structural body provided with the eight molded articles was determined from the energy absorbing characteristics of one molded article using a simulation software for nonlinear structural analysis LS-DYNA. The calculated acceleration was 12.58 G. Thus, it has been revealed that the actually measured acceleration value is nearly the same as the calculated value, indicating that the skin-covered foamed molded article of the present invention allows construction of a large scale energy absorbing member showing energy absorbing performance as designed.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein. The teachings of Japanese Patent Application No. 2014-67534, filed Mar. 28, 2014, inclusive of the specification, claims and drawings, are hereby incorporated by reference herein.

What is claimed is:

1. A skin-covered foamed molded article comprising a polystyrene-based resin expanded beads molded article, and a skin covering a substantially entire surface of the expanded beads molded article, wherein said skin is formed of an olefinic thermoplastic elastomer and covers the expanded beads molded article in such a manner that the skin is in contact with the surface thereof but is unbonded thereto.

2. The skin-covered foamed molded article according to claim 1, wherein the expanded beads molded article has a voidage of 5% or less and a fusion bonding rate of 20 to 70%.

3. The skin-covered foamed molded article according to claim 1, wherein the expanded beads molded article has an apparent density of 15 to 50 kg/m³.

4. The skin-covered foamed molded article according to claim 1, wherein the skin has an average thickness of 1 to 5 mm.

5. The skin-covered foamed molded article according to claim 1, wherein the olefinic thermoplastic elastomer has a Durometer A hardness of 85 or less.

6. The skin-covered foamed molded article according to claim 1, wherein the skin is a blow-molded product and defines a hollow interior space therein and the expanded beads molded article is obtained by heating and fusion-bonding polystyrene-based resin expanded beads placed in said hollow interior space.

7. An energy absorbing member comprising a skin-covered foamed molded article according to claim 1.
